(19) United States
(12) Patent Application Publication
(10) Pub. No.: US 2004/0216303 A1
(43) Pub. Date: Nov. 4, 2004

(54) Thick film current sensing resistor and method

(76) Inventors: Carl W. Berlin, West Lafayette, IN (US); Dwadasi H. Sarma, Kokomo, IN (US); Joel F. Downey, Kokomo, IN (US); James R. Morken, Fremont, IN (US); William Hart, Kokomo, IN (US); Kevin J. McGirr, Dayton, OH (US)

Correspondence Address: DELPHI TECHNOLOGIES, INC., M/C 480-410-202, PO BOX 5052, TROY, MI, 48007, US

(21) Appl. No.: 10/427,599

(22) Filed: May 1, 2003

(51) Int. Cl. H01C 7/00

(52) U.S. Cl. 29/610.1; 338/203; 29/620

(57) ABSTRACT

A thick film current sensing resistor is provided having an input terminal for receiving an electrical current, and an output terminal for outputting the electrical current. A film of resistive material extends between the input and output terminals and is electrically coupled to the input and output terminals so that current flows through the film of resistive material. A pair of sensing terminals are provided to sense a voltage potential across the film of resistive material. The sensed voltage provides an indication of the current. An gap is formed in the film of resistive material between the input and output terminals and the sensing terminals. The length of the gap defines a voltage sensing point of the sensing terminals.

### TECHNICAL FIELD

The present invention generally relates to thick film resistors, and more particularly to a thick film current sensing resistor and method of trimming the thick film current sensing resistor.

### BACKGROUND OF THE INVENTION

Current sensing resistors are commonly used to sense or measure electrical current flow in electronic circuitry. Current sensing resistors typically sense current by measuring the voltage potential drop across the resistor. The current is then calculated as a function of V=I·R; where I is current, V is voltage, and R is a resistance of the resistor. An example of a thick film current sensing resistor is disclosed in U.S. Pat. No. 5,221,644, entitled “Thick Film Sense Resistor Composition and Method of Using the Same.”

Conventional thick film current sensing resistors commonly employ a printed ink film of bulk resistor material, such as palladium silver, extending between an input terminal and an output terminal. The input and output terminals are made of an electrically conductive material for allowing current to flow into and out of the bulk resistor material. The film of bulk resistor material is typically applied as a printed ink that is fired to cure the ink. The film of resistor material overlays portions of each of the input and output terminals, that, due to conductor diffusion, form interaction regions which generally experience a high temperature coefficient of resistance (TCR) through the bulk resistor material. The current forced through the resistor is typically sensed by measuring the voltage drop across a pair of sense terminals which are electrically coupled to the input and output terminals in some current sensing resistors.

In some resistors, the sensing terminals measure the voltage drop across part of the conductive input and output terminals as well as the bulk resistor material. Because the thermal coefficient of resistance values of the conductive input and output terminals and interactive regions are typically higher than that of the bulk resistor material, the observed temperature coefficient of resistance may be higher than that of bulk resistor material alone. This becomes even greater as the aspect ratio of the resistor decreases to create lessened resistance.

To eliminate adverse impact of the interaction region on the thermal coefficient of resistance, it has been proposed to connect the sense terminals directly to the bulk resistive material. In doing so, the sensing terminals are positioned away from and between the conductor/resistor interfaces so that the voltage drop across only the bulk resistor material is sensed. In doing so, the observed resistance and temperature coefficient of resistance becomes a function of the bulk resistor material itself. As mentioned above, the resistance may be adjusted upwards from its printed value by trimming across the current path.

The thick film current sensing resistor may be laser trimmed into the path of current flow to increase the effective resistance of the resistor from its printed value. The conventional laser trimming generally includes forming a gap (opening) extending into the bulk resistor material substantially perpendicular to the current flow path. Adjustment of the resistance by trimming across the current path may result in current crowding at the laser kerf (tip) which can cause excessive heating and non-uniform current, resulting in potential crack propagation from the laser kerf.

While the above-described thick film current sensing resistors allow for sensing of electrical current, these approaches may suffer from a number of drawbacks. Many conventional current sensing resistors generally are limited in that the printed resistance value may not be lowered and high currents may not be accurately sensed. Because the sensing resistor film has a specific sheet resistance (e.g., 70 milliohms/square), reduced resistance values below 10 milliohms, for example, may not be realized without losing control of the temperature coefficient of resistance or consuming excessive circuit area with extremely low aspect ratios. Even at these low aspect ratios, the resistance limits are often constrained by the need to trim the resistor up in resistance from its printed nominal value. Resistors printed above the trim nominal resistance will generally result in circuit scrap.

Accordingly, it is therefore desirable to provide for a thick film current sensing resistor that may trimmed to reduce the resistance from its printed nominal value. It is further desirable to provide for a thick film current sensing resistor that reduces or eliminates the need for laser kerfs and the drawbacks associated therewith.

### SUMMARY OF THE INVENTION

According to one aspect of the present invention, a film resistor is provided which is particularly adapted to sense electrical current. The film resistor includes an input terminal for receiving an electrical current, and an output terminal for outputting the electrical current. A film of resistive material extends between the input and output terminals and is electrically coupled to the input and output terminals. Electrical current flows through the film of resistive material. A pair of sensing terminals are provided to sense a voltage across the resistive material. The sensed voltage provides an indication of the current. An opening extends into the film of resistive material between the input and output terminals. The length of the opening defines a voltage sensing point of the sensing terminals.

According to another aspect of the present invention, a method of trimming a film resistor is provided. The method includes the steps of providing an input terminal and an output terminal, providing a pair of sensing terminals, forming a film of resistive material extending between the first and second input terminals and further extending between the pair of sensing terminals, and forming an opening extending into the film of resistive material between the input and output terminals.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is an electrical circuit diagram of a current sensing resistor application; and

FIG. 2 is a top view of a thick film current sensing resistor according to the present invention.

### DESCRIPTION OF THE PREFERRED EMBODIMENT

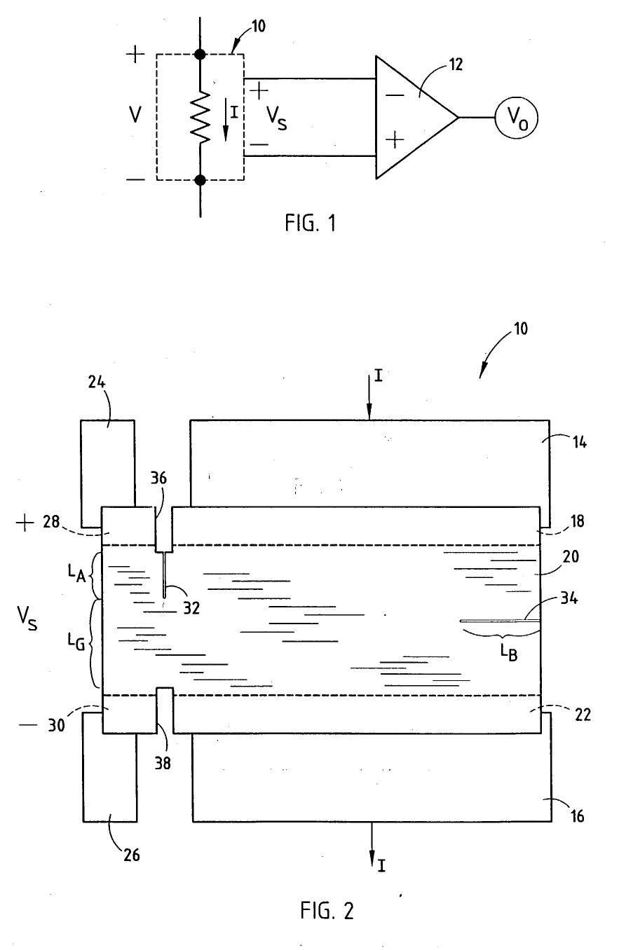

Referring to FIG. 1, a current sensing resistor 10 is illustrated for use in sensing or measuring electrical current flow in electronic circuitry. The current sensing resistor 10 is electrically coupled to an operational amplifier 12 which measures differentially the voltage drop across the resistor 10 at a pair of sensing terminals. The electrical current is calculated by the equation V=I·R; where I is the current, V is the voltage, and R is the resistance of the sensing resistor 10. The current sensing resistor 10 is a thick film resistor as shown in FIG. 2 and described herein.

Referring to FIG. 2, the thick film current sensing resistor 10 is illustrated having an input terminal 14 for receiving an electrical current signal I, and an output terminal 16 for outputting the electrical current signal I. The input and output terminals 14 and 16 are made of an electrically conductive material, such as palladium silver. Also shown are a pair of sensing terminals 24 and 26. The sensing terminals 24 and 26 are likewise made of an electrically conductive material, such as palladium silver. The ratio of palladium and silver employed in each of the electrically conductive terminals 14, 16, 24, and 26 is selected to achieve a desired conductivity. The pair of sensing terminals 24 and 26 are employed to sense a voltage differential V_{S} across a sensing gap length L_{G} of the resistor 10, with the voltage differential V_{S} being indicative of the electrical current I.

The current sensing resistor 10 is a thick film resistor employing an ink film of electrically resistive material 20 that is printed on top of a substrate, and is sequentially fired to cure the ink film. The film of resistive material 20 is formed in contact with the first and second terminals 14 and 16, respectively, and the pair of sensing terminals 24 and 26. The printed ink film of resistive material 20 partially overlaps the first terminal 14 and sensing terminal 24. Likewise, the printed ink film of resistive material 20 partially overlaps the second terminal 16 and sensing terminal 26. Accordingly, the bulk resistor material 20 provides a direct electrical connection to each of the first and second terminals 14 and 16 and the sensing terminals 24 and 26.

According to one embodiment, the bulk resistor material 20 may include a composition containing palladium and silver of a ratio to obtain to a desired sheet resistance and a low temperature coefficient of resistance, as disclosed in issued U.S. Pat. No. 5,221,644. The entire disclosure of the aforementioned U.S. patent is hereby incorporated herein by reference. Techniques for printing and firing the resistor composition include those known in the art, for example, as described in U.S. Pat. No. 4,452,726, the disclosure of which is hereby incorporated herein by reference. The printed and fired thick film resistor material 20 may have a thickness in the range of about 10-15 microns, according to one embodiment.

The interaction of the bulk resistor material 20 overlapping the first conductive terminal 14 creates an interaction region 18. Similarly, the bulk resistor material 20 overlapping the second conductive terminal 16 likewise creates an interaction region 22. It should further be appreciated that interaction regions 28 and 30 are created by the overlap of the bulk resistor material 20 overlapping the pair of sensing terminals 24 and 26, respectively. The interaction regions are created by conductor diffusion due to the electrically conductive material interacting with the bulk resistor material 20 in the overlapping regions. Interaction regions are known to cause variations in the thermal coefficient of resistance, due to the inter diffusion of the conductor and resistor materials.

According to the present invention, the thick film current sensing resistor 10 is formed having a controlled length gap or opening 32 extending into the bulk resistor material 20 between the first and second terminals 14 and 16 and the sensing terminals 24 and 26. The gap 32 is formed by laser trimming to remove (trim) a section of resistive material from the bulk resistor material 20. Also shown is a first rectangular slot 36 formed in the bulk resistor material 20 in a region between the first conductive terminal 14 and sensing terminal 24. A second rectangular slot 38 is likewise formed in the bulk resistor material 20 between the second conductive terminal 22 and sensing terminal 26. The gap 32 extends from the first slot 36 into the bulk resistor material 20 such that the gap 32 follows the current flow path. According to one embodiment, the gap 32 has a minimum gap width of approximately ten (10) microns. The length of the gap 32 is shown by L_{A}. The gap 32 provides a sensing point for the sense terminals 24 to 26 to sense a differential voltage V_{S} throughout a length L_{G} of the bulk resistor material 20 at a point starting at the end of gap 32 to sensing terminal 26. Accordingly, the length L_{A} of gap 32 determines the sensing length L_{G} of the bulk resistor material 20, such that an increased length L_{A} of gap 32 decreases the sensing length L_{G} and this the sensing resistance. The gap 32 may be formed by laser trimming according to known laser trimming techniques such as those using a Yttrium Aluminum Garnet (YAG) laser which is commonly employed for thick film processing.

By employing a laser trimming approach to form laser trimmed gap 32, the bulk resistor material 20 may be printed to form a thick film current sensing resistor 10. The length L_{A} of laser trimmed gap 32 may be formed so as to decrease the effective resistance seen at the sensing terminals 24 and 26. The measured resistance value of the resistor 10 can be reduced by using the laser trim to narrow the sensing length L_{G}. As the sensing gap 32 approaches the opposite side of the thick film, the sensing length L_{G} narrows, thus resulting in a reduced distance across which the voltage V_{S} is sensed. Since the laser trimmed gap 32 follows the current path, current crowding at the laser tip of gap 32 is not present.

Also shown is an optional second laser trimmed opening or gap 34 formed in the current path and oriented substantially perpendicular to the current flow path through the bulk resistor material 20. The second gap 34 is an optional opening that may also be formed by laser trimming. The second gap has a length L_{B}. The resistance of current sensing resistor 10 may be increased from its printed value by forming gap 34, such that the greater the length L_{B} of gap 34, the greater the resistance across resistor 10. By providing both laser trim gaps 32 and 34, the current sensing resistor 10 may be increased and decreased in resistance following the initial printing and firing of the resistor 10. However, the second gap 34 may cause in the resistor 10 current non-uniformity due to the laser kerf.

Accordingly, the thick film current sensing resistor 10 of the present invention advantageously extends the lower end of resistance values available for current sensing without adversely impacting circuit area and the temperature coefficient of a resistance of the resistor 10. While the resistor 10 has been described herein in connection with a thick film current sensing resistor, it should be appreciated that the resistor 10 may be used for various applications in connection with electronic circuitry.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. (cancelled)

2. (cancelled)

3. (cancelled)

4. (cancelled)

5. (cancelled)

6. (cancelled)

7. (cancelled)

8. (cancelled)

9. (cancelled)

10. A method of forming a film resistor, said method comprising the steps of:
providing a pair of terminals comprising an input terminal and an output terminal;
providing a pair of sensing terminals;
forming a film of resistive material extending between the input and output terminals and further extending between the pair of sensing terminals; and
forming a gap extending into the film of resistive material between the pair of input and output terminals and the pair of sensing terminals.

11. The method as defined in claim 10, wherein the film resistor is a current sensing resistor.

12. The method as defined in claim 10, wherein the step of forming the gap comprises laser trimming an elongated gap.

13. The method as defined in claim 10 further comprising the step of forming a first slot extending into the film of resistive material between one of the input and output terminals and one of the pair of sensing terminals.

14. The method as defined in claim 13, wherein the gap is formed extending from the slot.

15. The method as defined in claim 10 further comprising the step of forming a first slot extending into the film of resistive material between the input terminal and one of the sensing terminals, and forming a second slot extending into the film of resistive material between the output terminal and the other of the sensing terminals.

16. The method as defined in claim 10, wherein the input and output terminals are separated from the pair of sensing terminals.

17. The method as defined in claim 10 further comprising the step of laser trimming a second gap extending into the film of resistive material to increase resistance of the resistor, wherein the second gap is arranged substantially perpendicular to flow of the current.

18. The method as defined in claim 10, wherein the film of resistive material has a thickness in the range of about 10-15 microns.

19. The method as defined in claim 10, wherein the step of forming a film of resistive material comprises forming a film of resistive material to provide a thick film resistor.

20. The method as defined in claim 10 further comprising the step of forming a transition region between the film of resistive material and each of the input and output terminals.

21. A method of forming a thick film resistor, said method comprising the steps of:
providing an input terminal and an output terminal;
providing a pair of sensing terminals;
forming a film of resistive material extending between the input and output terminals and further extending between the pair of sensing materials, wherein the film of resistive material forms a first transition region near the input terminal and a second transition region near the output terminal; and
forming a gap extending into one of the transition regions and into the film of resistive material between the input and output terminals and the pair of sensing terminals.

22. The method as defined in claim 21, wherein the thick film resistor is a current sensing resistor.

23. The method as defined in claim 21, wherein the step of forming the gap comprises laser trimming an elongated gap.

24. The method as defined in claim 21, wherein the gap is formed extending from a slot.

25. The method as defined in claim 21 further comprising the step of forming a first slot extending into the film of resistive material between the input terminal and one of the sensing terminals, and forming a second slot extending into the film of resistive material between the output terminal and the other of the sensing terminals.

26. The method as defined in claim 21, wherein the input and output terminals are separated from the pair of sensing terminals.

27. The method as defined in claim 21 further comprising the step of laser trimming a second gap extending into the film of resistive material to increase resistance of the resistor, wherein the second gap is arranged substantially perpendicular to flow of current.

28. The method as defined in claim 21, wherein the film of resistive material has a thickness in the range of about 10-15 microns.

29. The method as defined in claim 21, wherein the step of forming a gap reduces effective resistance sensed between the pair of sensing terminals.
